(19) United States
(12) Patent Application Publication
(10) Pub. No.: US 2015/0109540 A1
(43) Pub. Date: Apr. 23, 2015

(54) IN-CELL TOUCH PANEL AND MANUFACTURING METHOD THEREOF

(71) Applicant: CHUNGHWA PICTURE TUBES, LTD., TAOYUAN (TW)

(72) Inventors: Chih-Wei CHANG, Taoyuan County (TW); Kun-Chi CHIU, Miaoli County (TW); Shu-Wen CHANG, Taoyuan County (TW); Chao-Wei WEI, Taoyuan County (TW); Chun-Chung WU, Taoyuan County (TW)

(73) Assignee: CHUNGHWA PICTURE TUBES, LTD., TAOYUAN (TW)

(21) Appl. No.: 14/142,938

(22) Filed: Dec. 30, 2013

(30) Foreign Application Priority Data
Oct. 17, 2013 (TW) 102137530

(51) Int. Cl. G06F 3/041; G02F 1/1333; G02F 1/1335; G06F 3/0354

(52) U.S. Cl. CPC G06F 3/0412; G06F 3/03547; G02F 1/13338; G02F 1/133514; G02F 1/133512; G02F 1/133345; G06F 2203/04103
USPC 349/12; 29/846

(57) ABSTRACT

An in-cell touch panel includes a transparent substrate having a first surface, a plurality of drive-end traces and a plurality of receive-end traces disposed on the first surface of the transparent substrate, and a plurality of color photoresists. The drive-end traces and the receive-end traces are utilized as a black matrix for defining a plurality of pixel regions. The color photoresists are disposed on the first surface of the transparent substrate and disposed in the pixel regions respectively.

### RELATED APPLICATIONS

This application claims priority to Taiwanese Application Ser. No. 10217530, filed Oct. 17, 2013, which is herein incorporated by reference.

### BACKGROUND

1. Field of Invention

The present invention relates to an in-cell touch panel and fabricating method thereof. More particularly, the present invention relates to an in-cell touch panel having a conductive opaque layer and manufacturing method thereof.

2. Description of Related Art

With the development of touch control technique, an input module can be combined with a display module in the electronic devices, such that the electronic devices can be thinner and easily carried. Also, with the development of communication technique, the mobile devices having touch control function, such as smart phones or tablet computers become popular and are widely used in our daily life.

The recent trend of the mobile device is thinner and thinner for raising mobility of the mobile device and improving market competitiveness. Various types of touch panel, such as one glass solution (OGS) touch panels, on-cell touch panels, and in-cell touch panels are utilized in the mobile devices for reducing the thickness of the mobile devices.

An example of a method for fabricating the in-cell touch panel is discussed as following. A color filter layer is formed on a glass substrate, which includes forming a black matrix and a color photoresist layer. Then the glass substrate is turned to form a sensing pattern thereon. The product formed by the method is shown in FIG. 9, which is a cross-sectional schematic view of an embodiment of a conventional in-cell touch panel. The in-cell touch panel 200 includes a glass substrate 210, a sensing pattern layer 220 formed on one surface of the glass substrate 210, and a color filter layer 230 formed on an opposite surface of the glass substrate 210. In order to protect the sensing pattern layer 220, the in-cell touch panel 200 further includes a cover glass 240 disposed on the sensing pattern layer 220.

Generally, the touch panels are test while the fabrication is completed. The touch panel may be scraped when a defect is found in the step of testing, such results in low yield and unnecessary cost.

### SUMMARY

The present invention provides an in-cell touch panel. By integrating the black matrix with the sensing pattern, the thickness of the in-cell touch panel can be reduced, and the fabrication thereof can be simplified.

An aspect of the invention provides an in-cell touch panel, which includes a transparent substrate having a first surface, a plurality of drive-end traces and a plurality of receive-end traces disposed on the first surface of the transparent substrate, and a plurality of color photoresists. The drive-end traces and the receive-end traces are utilized as a black matrix for defining a plurality of pixel regions. The color photoresists are disposed on the first surface of the transparent substrate and disposed in the pixel regions respectively.

In one or more embodiments of the invention, the in-cell, touch panel further includes a plurality of insulating portions disposed at a plurality of interlaced regions of the drive-end traces and the receive-end traces respectively, wherein the insulation portions are disposed between the drive-end traces and the receive-end traces.

In one or more embodiments of the invention, the in-cell touch panel further includes a transparent insulating layer disposed between the drive-end traces and the receive-end traces.

In one or more embodiments of the invention, the in-cell touch panel further includes a plurality of drive terminals electrically connected to the drive-end traces in a one-to-one manner or in a one-to many manner, and a plurality of receive terminals electrically connected to the receive-end traces in a one-to-one manner or in a one-to-many manner.

In one or more embodiments of the invention, the drive-end traces construct a plurality of first sensing units, the receive-end traces construct a plurality of second sensing units, and the first sensing units and the second sensing units are alternately arranged.

In one or more embodiments of the invention, the in-cell touch panel further includes a plurality of opaque insulating materials connecting the first sensing units with the second sensing units, wherein the pixel regions are defined by the drive-end traces, the receive-end traces, and the opaque insulating materials.

In one or more embodiments of the invention, the drive-end traces construct at least one finger-shaped sensing unit, the receive-end traces construct a plurality of opposing sensing units, and the opposing sensing units and the finger-shaped sensing unit are arranged in a many-to-one manner alternately.

In one or more embodiments of the invention, the in-cell touch panel further comprising a plurality of opaque insulating materials connecting the finger-shaped sensing units with the opposing sensing units, wherein the pixel regions are defined by the drive-end traces, the receive-end traces, and the opaque insulating materials.

Another aspect of the invention provides a method for manufacturing an in-cell touch panel, the method includes the following steps: providing a transparent substrate, forming a plurality of drive-end traces and a plurality of receive-end traces on a first surface of the transparent substrate respectively, wherein the drive-end traces and the receive-end traces are regarded as a black matrix for defining a plurality of pixel regions, and forming a plurality of color photoresists on the first surface of the transparent substrate, wherein the color photoresists are disposed in the pixels regions respectively.

In one or more embodiments of the invention, the drive-end traces and the receive-end traces are made of opaque conductor.

In one or more embodiments of the invention, the material of the drive-end traces and the receive-end traces is gold (Au), silver (Ag), copper (Cu), platinum (Pt), nickel (Ni), palladium (Pd), ink, carbon (C), organometallic compound having alkyl group or benzyl group, or graphene

In one or more embodiments of the invention, the drive-end traces and the receive-end traces are arranged orthogonally to each other.

In one or more embodiments of the invention, the method for manufacturing an in-cell touch panel further includes forming a plurality of insulating portions on the first surface of the transparent substrate after forming the drive-end traces, wherein the insulating portions partially overlap the drive-end traces, and forming the receive-end traces passing above the insulating portions and crossing the drive-end traces.

In one or more embodiments of the invention, the method for manufacturing an in-cell touch panel further includes forming a transparent insulating layer on the first surface of the transparent substrate and covering the drive-end traces, and forming the receive-end traces on the transparent insulating layer.

In one or more embodiments of the invention, the drive-end traces construct a plurality of first sensing units, the receive-end traces construct a plurality of second sensing units, and the first sensing units and the second sensing units are alternately arranged.

In one or more embodiments of the invention, the method for manufacturing an in-cell touch panel further includes forming a plurality of opaque insulating materials connecting the first sensing units with the second sensing units, wherein the pixel regions are defined by the drive-end traces, the receive-end traces, and the opaque insulating materials.

In one or more embodiments of the invention, the drive-end traces construct at least one finger-shaped sensing unit, the receive-end traces construct a plurality of opposing sensing units, and the opposing sensing units and the finger-shaped sensing unit are arranged in a many-to-one manner alternately.

In one or more embodiments of the invention, the method further includes forming a plurality of opaque insulating materials connecting the finger-shaped sensing units with the opposing sensing units, wherein the pixel regions are defined by the drive-end traces, the receive-end traces, and the opaque insulating materials.

It is to be understood that both the foregoing general description and the following detailed description are by examples, and are intended to provide further explanation of the invention as claimed.

### BRIEF DESCRIPTION OF THE DRAWINGS

FIG. 1 is a top view of an in-cell touch panel of the invention;

FIG. 2A and FIG. 2B are cross-sectional views ken along line A-A and line B-B as shown in FIG. 1 respectively;

FIG. 3-FIG. 7 are schematic flow charts of different embodiments of a method for fabricating the in-cell touch panel of the invention;

FIG. 8 is a flow chart of an embodiment of a method for fabricating the in-cell touch panel of the invention; and

FIG. 9 is a cross-sectional view of a conventional in-cell touch panel.

### DESCRIPTION OF THE EMBODIMENTS

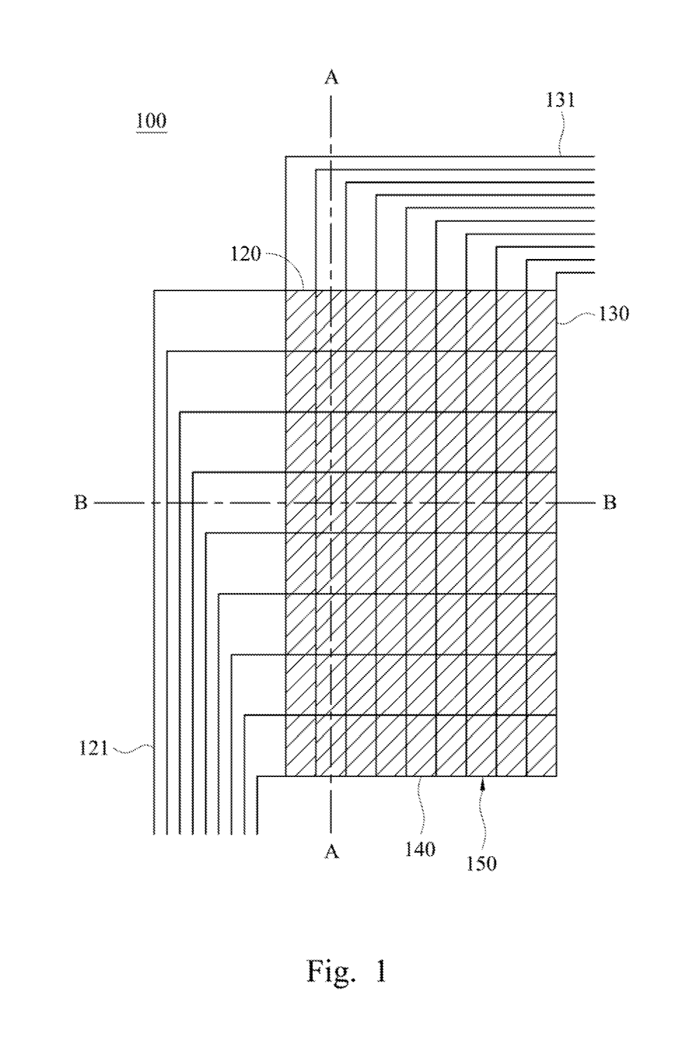

FIG. 1 is a top view of an in-cell touch panel of the invention. The in-cell touch panel 100 herein can be utilized as a part of a liquid crystal touch display. The in-cell touch panel 100 mainly includes an upper glass substrate, a touch related sensing layout, a black matrix layer, and a color photoresist layer. The in-cell touch panel 100 is operated with a display module and a control module as the liquid crystal touch display.

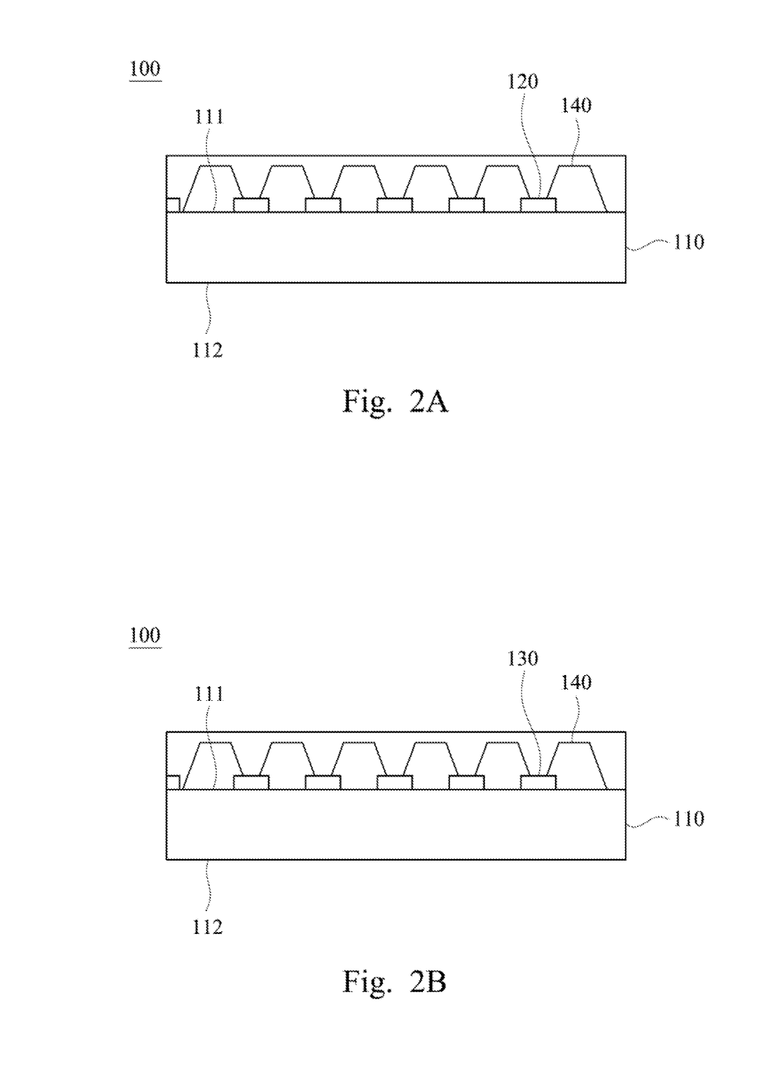

FIG. 2A and FIG. 2B are cross-sectional views taken along line A-A and line B-B as shown in FIG. 1 respectively. Regarding to FIG. 1, FIG. 2A and FIG. 2B, the in-cell touch panel 100 includes a transparent substrate 110, a plurality of drive-end traces 120, a plurality of receive-end traces 130, and a plurality of color photoresists 140. The transparent substrate 110 has a first surface 111 The drive-end traces 120 and the receive-end traces 130 are disposed on the first surface 111 of the transparent substrate 110. The drive-end traces 120 and the receive-end traces 130 are further utilized as a black matrix for defining a plurality of pixel regions 150. The drive-end traces 120 and the receive-end traces 130 are made of opaque conductor. The color photoresists 140 are disposed on the first surface 111 of the transparent substrate 110, and the color photoresists 140 are disposed in the pixel regions 150 respectively. The in-cell touch panel 100 is assembled with an active array substrate and a liquid crystal layer thereby forming a liquid crystal touch display module. The liquid crystal touch display module is further assembled to the control module thereby forming a liquid crystal touch display. Therefore, the transparent substrate 110 is also utilized as an upper substrate of the liquid crystal touch display. The in-cell touch panel 100 in the drawings shows merely a display area (A-A area), an external layout area surrounding the display area is not shown in the drawings.

In a conventional touch panel, the black matrix and the color photoresists are fabricated separately from the sensing pattern, such as the drive-end traces 120 and the receive-end traces 130. Thus the black matrix, the color photoresists, and the sensing pattern are formed in two different layers. On the contrary, in the present disclosure, the relative position of the drive-end traces 120, the receive-end traces 130 and the color photoresists 140 are well designed, and the drive-end traces 120 and the receive-end traces 130 are made of opaque materials, such that the drive-end traces 120 and the receive-end traces 130 may also provide the function of black matrix. Therefore, the black matrix, the color photoresists 140, and the sensing pattern are combined, and the drive-end traces 120, the receive-end traces 130, and the color photoresists 140 are formed in a single layer thereby reducing the thickness of the in-cell touch panel 100.

The material of the transparent substrate 110 can be glass, tempered glass, or acrylic. The transparent substrate 110 has a second surface 112 opposite to the first surface 111. The in-cell touch panel 100 may include a cover glass 113 disposed on the second surface 112. The cover glass 113 can be utilized as a display cover and provide protecting function.

The drive-end traces 120 and the receive-end traces 130 are made of opaque conductor, such as Au, Ag, Cu, Pt, Ni, Pd, ink, C, organometallic compound having alkyl group or benzyl group, or graphene. The present disclosure is not limited to above materials, a person having ordinary skill in the art may select the material of the drive-end traces 120 and the receive-end traces 130 according to actual requirements.

Reference is made to FIG. 1, the drive-end traces 120 and the receive-end traces 130 are arranged orthogonally to each other thereby defining the pixel regions 150. In other embodiments, the drive-end traces 120 can be not orthogonal to the receive-end traces 130. Namely, the pixels regions 150 can be defined by the proper arranged drive-end traces 120 and the receive-end traces 130 for containing color photoresists 140 within.

In some embodiments, the color photoresists 140 may include blue photoresists, red photoresisits, and green photoresists. The blue, red, and green photoresists may be aligned in row or column or other possible manner. The adjacent blue, red, and green photoresists may form a pixel. It should be noted that the color photoresists 140 as discussed are only illustrative, and the scope of the present invention should not be limited to this respect. A person having ordinary skill in the art may design the color photoresists according to actual requirements.

A method for fabricating the in-cell touch panel 100 includes providing the transparent substrate 110, and the drive-end traces 120 and the receive-end traces 130 are formed on the first surface 111 of the transparent substrate 110 respectively. The drive-end traces 120 and the receive-end traces 130 are regarded as the black matrix for defining the pixels regions 150. Then the color photoresists 140 are formed on the first surface 111 of the transparent substrate 110 and are disposed in the pixel regions 150 respectively.

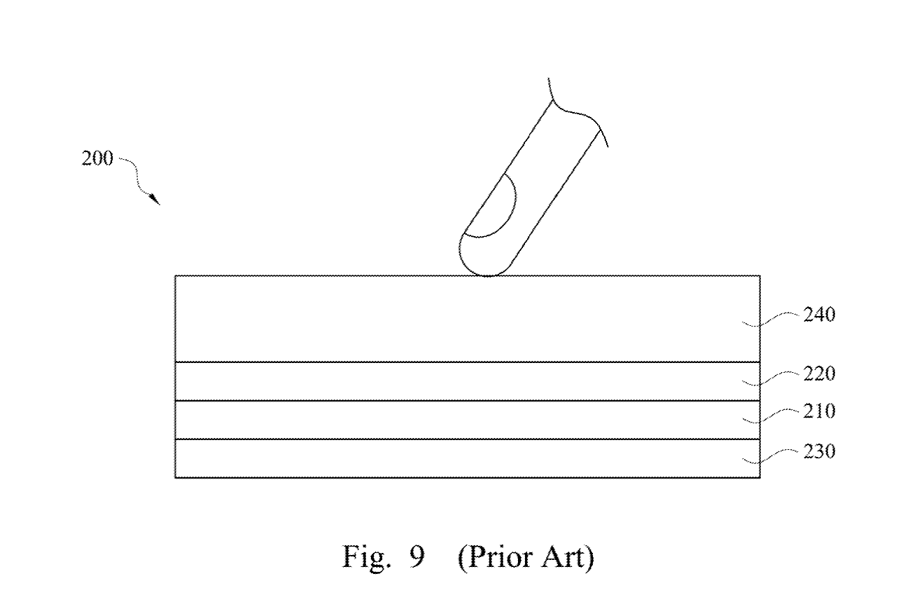

Furthermore, the drive-end traces 120, the receive-end traces 130, and the color photoresists 140 are formed on the same side of the transparent substrate 110, such that the transparent substrate 110 can be utilized as the display cover of the in-cell touch panel 100. Therefore, the cover glass 240 of the conventional in-cell touch penal 200 as shown in FIG. 9 can be omitted'. Comparing with the conventional in-cell touch panel, the cover glass is omitted in the present embodiment, so that the thickness of the in-cell touch panel 100 can be further educed.

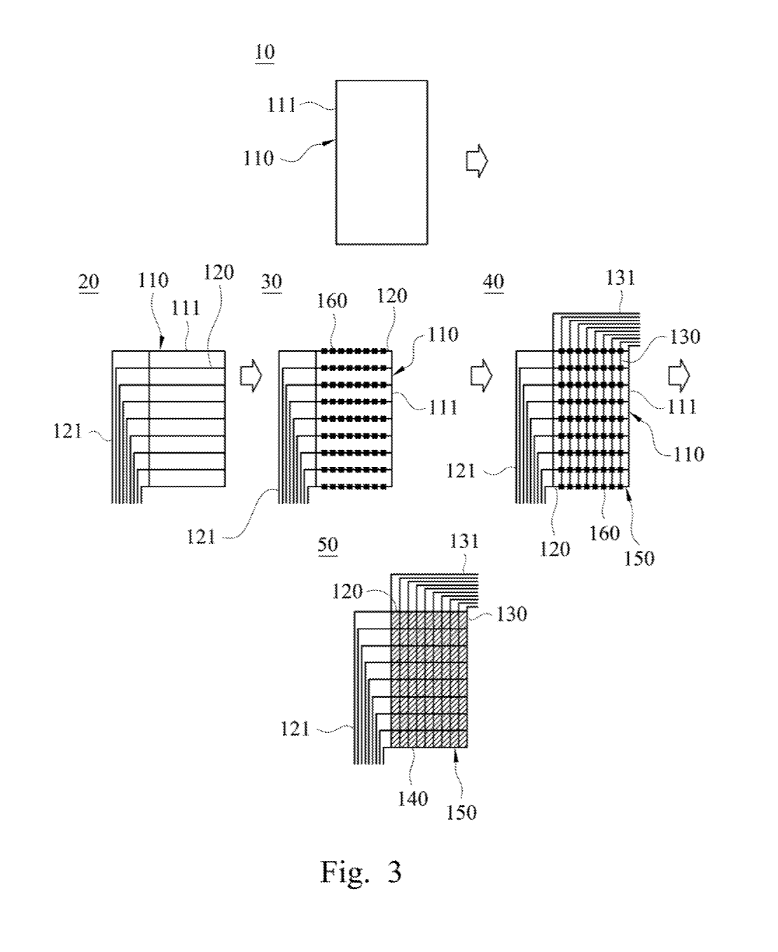

FIG. 3 is a schematic flow chart of an embodiment of a method for fabricating the in-cell touch panel of the invention. In step 10, a transparent substrate 110 is provided.

In step 20, a plurality of drive-end traces 120 are formed on the first surface 111 of the transparent substrate 110.

In step 30, a plurality of insulating portions 160 are formed on the first surface 111 of the transparent substrate 110, and the insulating portions 120 partially overlap the drive-end traces 120.

In step 40, a plurality of receive-end traces 130 are formed on the first surface 111 of the transparent substrate 110. The receive-end traces 130 pass above the insulating portions 160 and cross the drive-end traces 120. The drive-end traces 120 and the receiving-end traces 130 are utilized as a black matrix for defining a plurality of pixel regions 150.

In step 50, a plurality of color photoresists 140 are formed on the first surface 111 of the transparent substrate 110, The color photoresists 140 are disposed in the pixels regions 150 respectively.

Step 40 may further include testing the in-cell touch panel 100. If there is any defect found in this step, the in-cell touch panel 100 can be scraped directly. Comparing to the conventional in-cell touch panel process, i.e., the color photoresist layer and the black matrix are made on a side of the substrate, and the substrate is turned to form the sensing pattern thereon, then the product thereof is test, the sensing pattern (e.g. the drive-end traces 120 and the receive-end traces 130) of the in-cell touch panel 100 are test before forming the color photoresists 140 in the present disclosure. Thus the product can be scraped directly before the process of forming the color photoresists 140, the waste of forming the unnecessary color photoresists 140 can be prevented.

Furthermore, the black matrix is integrated with the sensing pattern in the present disclosure, such that the steps of fabricating the in-cell touch panel 100 of the present disclosure are less than the conventional process. Therefore, by using the present disclosure, the yield of the in-cell touch panel 100 can be increased, and the number of masks can be reduced during the fabrication.

Also, the drive-end traces 120, the receive-end traces 130, the color photoresists 140, and the insulating portions 160 are all formed on the first surface 111 of the transparent substrate 110. Comparing to the conventional fabricating method, the step of turning the substrate can be omitted thereby reducing fabricating steps and improving yield.

As disclosed above, the in-cell touch panel 100 may further include plural insulating portions 160 respectively corresponding to all of the interlaced regions of the drive-end traces 120 and the receive-end traces 130. The insulating portions 160 are disposed between the drive-end traces 120 and the receive-end traces 130. The insulating portions 160 are utilized to insulate the drive-end traces 120 and the receive-end traces 130.

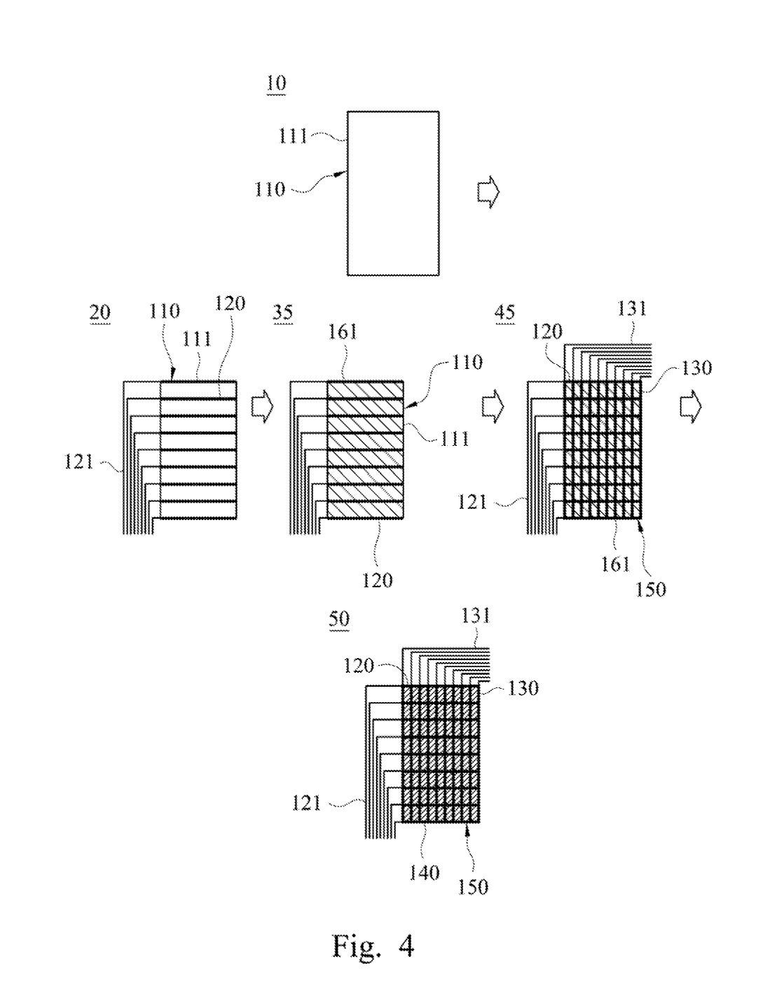

FIG. 4 is a schematic flow chart of another embodiment of the method for fabricating the in-cell touch panel of the invention. In this embodiment, the main distinguishing features from the method disclosed in FIG. 3 are that the step 30 is replaced by step 35, and the step 40 is replaced by step 45.

In step 35, a transparent insulating layer 161 is formed on the first surface 111 of the transparent substrate 110, and the transparent insulating layer 161 covers the drive-end traces 120.

In step 45, the receive-end traces 130 are formed on the transparent insulating layer 161. The drive-end traces 120 and the receive-end traces 130 are made of opaque conductor and are regarded as the black matrix for defining the pixel regions 150.

Accordingly, the in-cell touch panel 100 made by this embodiment also includes the transparent insulating layer 161 formed between the drive-end traces 120 and the receive-end traces 130. The function of the transparent insulating layer 161 is similar to the function of the insulating portions 160, which is utilized to insulate the drive-end traces 120 and the receive-end traces 130.

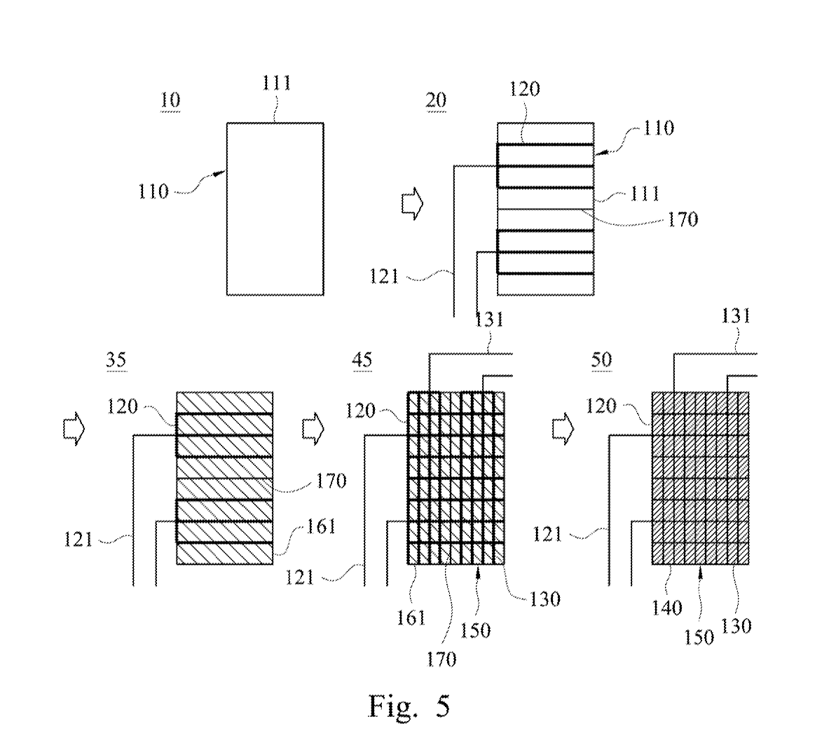

FIG. 5 is a schematic flow chart of yet another embodiment of the method for fabricating the in-cell touch panel of the invention. The steps in this embodiment are similar to the embodiment disclosed in FIG. 4, the difference between two embodiments is that, in FIG. 4, the drive-end traces 120 are connected to a plurality of drive terminals 121 in a one-to-one manner, and the receive-end traces 130 are connected to a plurality of receive terminals 131 in a one-to-one manner; in this embodiment (FIG. 5), the drive terminals 121 and the drive-end traces 120 are connected in a one-to-many manner, and the receive terminals 131 are connected to the receive-end traces 130 in a one-to-many manner.

Accordingly, the in-cell touch panel 100 includes the plurality of drive terminals 121 and the plurality of receive terminals 131. The drive terminals 121 can be connected to the drive-end traces 120 in a one-to-one or one-to-many manner. The receive terminals 131 can be connected to the receive-end traces 130 in a one-to-one or one-to-many manner. The drive terminals 121 are connected to a drive unit, such as a drive chip. The receive terminals 131 are connected to a processing unit.

As shown in the step 20 or step 45 in FIG. 5, the first surface 111 may include a blank zone without drive-end traces 120 and receive-end traces 130 applied thereon. Thus the pixel regions 150 cannot be defined at the blank zone because of lacking the black matrix. Therefore, the in-cell touch panel 100 of this embodiment may further include a plurality of opaque materials 170 disposed at the blank zone for defining the pixel regions 150. The opaque materials 170 do not touch the drive-end traces 120 or the receive-end traces 130 in order to prevent the situation of unwanted interconnection between the opaque materials 170 and the drive-end traces 120 and the receive-end traces 130. Thus the material of the opaque materials can be the same as the material of the drive-end traces 120 and the receive-end traces 130, and the opaque materials 170 can be integrate formed with the drive-end traces 120 or the receive-end traces 130 thereby reducing process steps and the number of masks. In some embodiments, the opaque materials 170 can be different from the material of the drive-end traces 120 and the receive-end' traces 130, for example, the opaque materials can be insulating material.

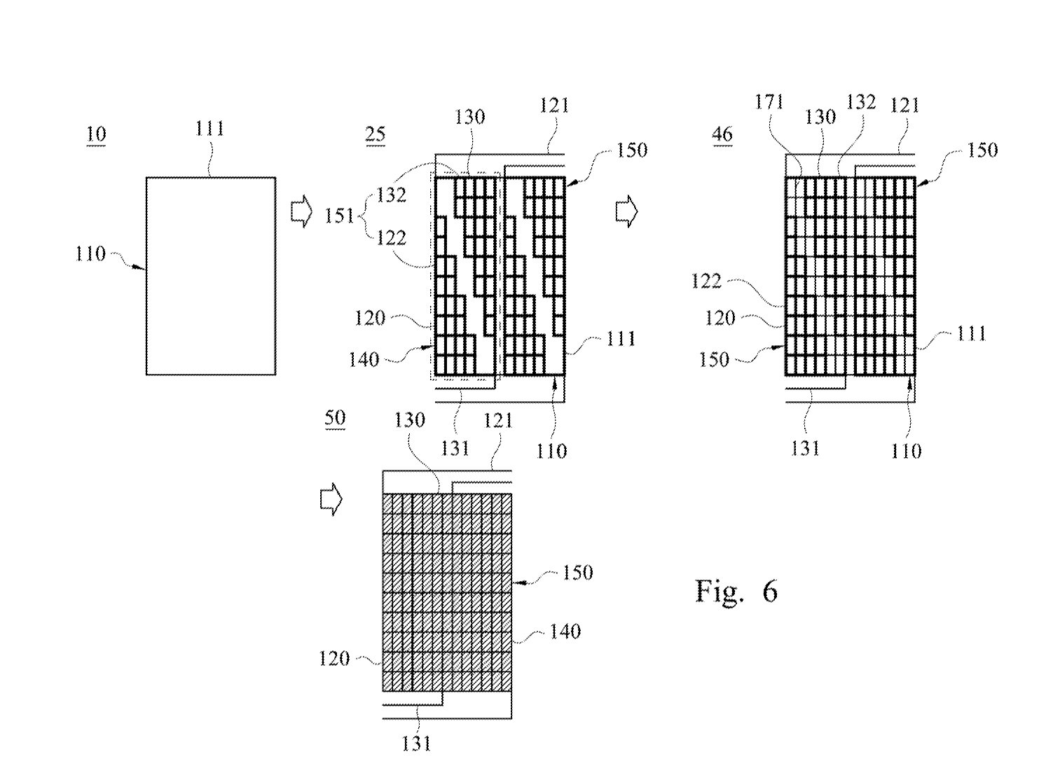

FIG. 6 is a schematic flow chart of another embodiment of the method for fabricating the in-cell touch panel of the invention. The drive-end traces 120 and the receive--end' traces 130 are formed in the same layer in this embodiment. In step 10, a transparent substrate 110 is provided.

In step 25, a plurality of drive-end traces 120 and a plurality of receive-end traces 130 are formed on a first surface 111 of the transparent substrate 110 respectively. The drive-end traces 120 construct a plurality of first sensing units 122, and the receive-end traces 130 construct a plurality of second sensing lines 132. The first sensing lines 122 and the second sensing lines 132 are alternately arranged.

In some embodiments, the first sensing units 122 and the second sensing units 132 may form a plurality of complementary sensing units 151 in a one-to-one manner, and the complementary sensing units 151 cover the whole first surface 111. In each of the complementary sensing units 151, the first sensing unit 122 is arranged at a side of the complementary sensing unit 151 and includes more than one pixel regions 150, and the second sensing unit 132 is disposed at an opposite side of the complementary sensing unit 150 and includes more than one pixel regions 150. More particularly, the shape of the complementary sensing unit 151 is a rectangular, and the first sensing unit 122 and the second sensing unit 132 are disposed at opposite corners of the complementary sensing unit 151.

In step 46, a plurality of opaque insulating materials 171 are formed on the transparent substrate 110 for connecting the first sensing units 122 with the second sensing units 132. The pixel regions 150 are defined by the drive-end traces 120, the receive-end traces 130, and the opaque insulating materials 171. Neither the drive-end traces 120 nor the receive-end traces 130 are formed between the first sensing units 122 and the second sensing units 132. Thus the first sensing units 122 can be insulated from the second sensing units 132. The pixel regions 150 between the first sensing units 131 and the second sensing units 132 can be defined by the opaque insulating materials 171.

In step 50, a plurality of color photoresists 140 are formed on the first surface 111 of the transparent substrate 110. The color photoresists 140 are disposed in the pixel regions 150 respectively.

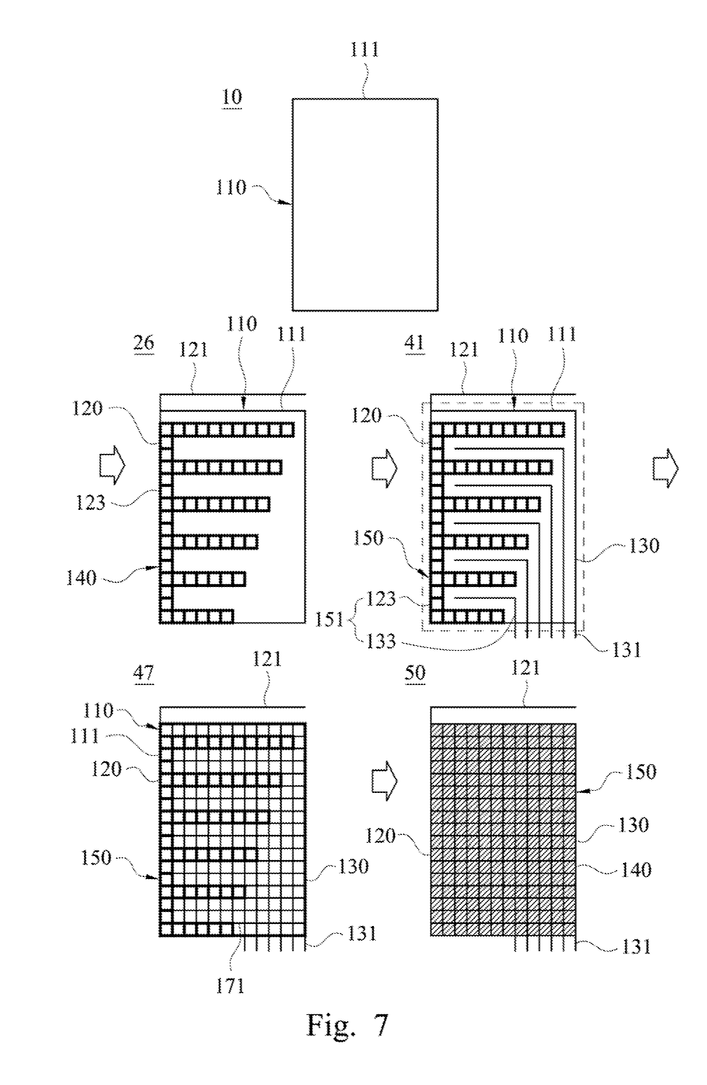

FIG. 7 is schematic flow chart of another embodiment of the method for fabricating the in-cell touch panel of the invention. In this embodiment, the drive-end traces 120 and the receive-end traces 130 are also formed in the same layer but in a shape of fingers. In step 10, a transparent substrate 10 is provided.

In step 26, a plurality of drive-end traces 120 are formed on the first surface 111 of the transparent substrate 110. The drive-end traces 120 form at least one finger-shaped sensing unit 123. (FIG. 7 illustrates only one finger-shaped sensing unit 123)

In step 41, a plurality of receive-end traces 130 are formed on the first surface 111 of the transparent substrate 110. The receive-end traces 130 form a plurality of opposing sensing units 133. The drive-end traces 120 and the receive-end traces 130 can he formed by the same mask. The opposing sensing units 133 and the finger-shaped sensing unit 123 are arranged in a many-to-one manner, and the opposing sensing units 133 are alternately arranged with the finger-shaped sensing unit 123. The finger-shaped sensing unit 123 and the opposing sensing units 133 may form a complementary sensing unit 151, and the plurality of the complementary units 151 cover the whole first surface 111.

In step 47, a plurality of opaque insulating materials 17 are formed on the transparent substrate 110 for connecting the finger-shaped sensing unit 123 with the opposing sensing units 133. The pixel regions 150 are defined by the finger-shaped sensing unit 123, the opposing sensing units 133, and the opaque insulating materials 171. Neither the drive-end traces 120 nor the receive-end traces 130 are formed between the finger-shaped sensing unit 123 and the opposing sensing units 133. Thus the finger-shaped sensing units 123 are insulated from the opposing sensing units 133. The pixel regions 150 between the finger-shaped sensing unit 123 and the opposing sensing units 133 can be defined by the opaque insulating materials 171.

In step 50, a plurality of color photoresists 140 are formed on the first surface 111 of the transparent substrate 110. The color photoresists 140 are disposed in the pixel regions 150 respectively.

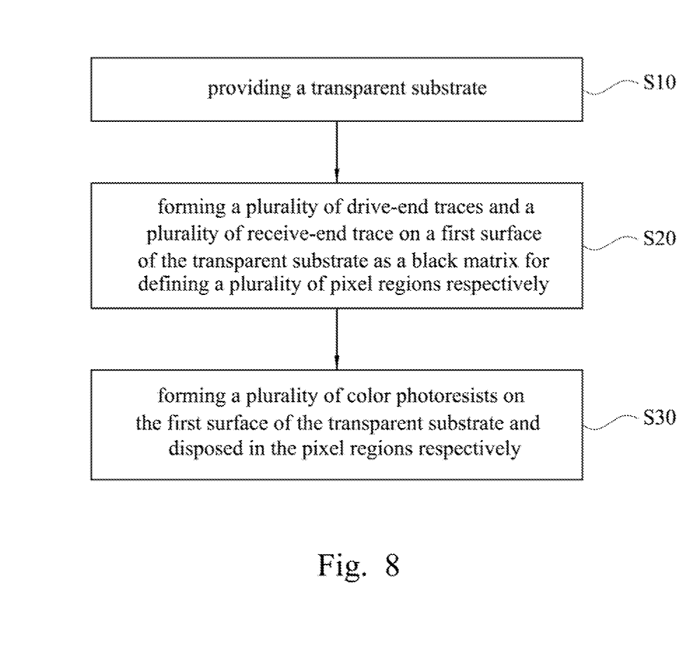

According to above embodiments, the method for fabricating the in-cell touch panel can be summed up in a flow chart as shown in FIG. 8. In step S10, a transparent substrate is provided. In step S20, a plurality of drive-end traces and a plurality of receive-end traces are formed on a first surface of the transparent substrate respectively. The drive-end traces and the receive-end traces can be formed by the same mask or different masks. The drive-end traces and the receive-end traces are further utilized as a black matrix for defining a plurality of pixel regions. In step S30, a plurality of color photoresists are formed on the first surface of the transparent substrate, and the color photoresists are disposed in the pixel regions respectively.

The sensing pattern, such as drive-end traces and receive-end traces, are made of opaque conductor in the present disclosure, such that the function of black matrix and sensing pattern can be integrated. Therefore the conventional black matrix (e.g. black photoresist) can be omitted thereby reducing thickness of the in-cell touch panel. Furthermore, the process of testing the sensing pattern is performed before forming the color photoresists, so that when there is any defect found in this step, the in-cell touch panel 100 can be scraped directly. Thus the waste of forming the unnecessary color photoresists can be prevented. Also, the steps for fabricating the in-cell touch panel are reduced such that the yield can be increased and the number of masks can be reduced.

What is claimed is:

1. An in-cell touch panel, comprising:
a transparent substrate having a first surface;
a plurality of drive-end traces and a plurality of receive-end traces disposed on the first surface of the transparent substrate, wherein the drive-end traces and the receive-end traces are further utilized as a black matrix for defining a plurality of pixel regions; and
a plurality of color photoresists disposed on the first surface of the transparent substrate and disposed in the pixel regions respectively.

2. The in-cell touch panel of claim 1, wherein the drive-end traces and the receive-end traces are made of opaque conductor.

3. The in-cell touch panel of claim 2, wherein the material of the drive-end traces and the receive-end traces is gold (Au), silver (Ag), copper (Cu), platinum (Pt), nickel (Ni), palladium (Pd), ink, carbon (C), organometallic compound having alkyl group or benzyl group, or graphene.

4. The in-cell touch panel of claim 1, wherein the drive-end traces and the receive-end traces are arranged orthogonally to each other.

5. The in-cell touch panel of claim 4, further comprising a plurality of insulating portions respectively corresponding to all of a plurality of interlaced regions of the drive-end traces and the receive-end traces, wherein the insulation portions are disposed between the drive-end traces and the receive-end traces.

6. The in-cell touch panel of claim 4, further comprising a transparent insulating layer disposed between the drive-end traces and the receive-end traces.

7. The in-cell touch panel of claim 1 further comprising:
a plurality of drive terminals electrically connected to the drive-end traces in a one-to-one manner or in a one-to many manner; and
a plurality of receive terminals electrically connected to the receive-end in a one-to-one manner or in a one-to-many manner.

8. The in-cell touch panel of claim 1, wherein the drive-end traces construct a plurality of first sensing units, the receive-end traces construct a plurality of second sensing units, and the first sensing nits and the second sensing units are alternately arranged.

9. The in-cell touch panel of claim 6, further comprising a plurality of opaque insulating materials connecting the first sensing units with the second sensing units, wherein the pixel regions are defined by the drive-end traces, the receive-end traces, and the opaque insulating materials.

10. The in-cell touch panel of claim 1, wherein the drive-end traces construct at least one finger-shaped sensing unit, the receive-end traces construct a plurality of opposing sensing units, the opposing sensing units and the finger-shaped sensing unit are arranged in a many-to-one manner, and the opposing sensing units are alternately arranged with the finger-shaped sensing unit

11. The in-cell touch panel of claim 10, further comprising a plurality of opaque insulating materials connecting the finger-shaped sensing units with the opposing sensing units, wherein the pixel regions are defined by the drive-end traces, the receive-end traces, and the opaque insulating materials.

12. A method for manufacturing an in-cell touch panel comprises the following steps:
providing a transparent substrate;
forming a plurality of drive-end traces and a plurality of receive-end traces on a first surface of the transparent substrate respectively, wherein the drive-end traces and the receive-end traces are regarded as a black matrix for defining a plurality of pixel regions; and
forming a plurality of color photoresists on the first surface of the transparent substrate, wherein the color photoresists are disposed in the pixels regions respectively.

13. The method of claim 12, wherein the drive-end traces and the receive-end traces are made of opaque conductor.

14. The method of claim 13, wherein the material of the drive-end traces and the receive-end traces is gold (Au), silver (Ag), copper (Cu), platinum (Pt), nickel (Ni), palladium (Pd), ink, carbon (C), organometallic compound having alkyl group or benzyl group, or graphene.

15. The method of claim 12, wherein the drive-end traces and the receive-end traces are arranged orthogonally to each other.

16. The method of claim 15, further comprising:
forming a plurality of insulating portions on the first surface of the transparent substrate after forming the drive-end traces, wherein the insulating portions partially overlap the drive-end traces; and
forming the receive-end traces passing above the insulating portions and crossing the drive-end traces.

17. The method of claim 15, further comprising:
forming a transparent insulating layer on the first surface of the transparent substrate and covering the drive-end traces; and
forming the receive-end traces on the transparent insulating layer.

18. The method I of claim 12, wherein the drive-end traces construct a plurality of first sensing units, the receive-end traces construct a plurality of second sensing units, and the first sensing units and the second sensing units are alternately arranged.

19. The method of claim 18, further comprising forming a plurality of opaque insulating materials connecting the first sensing units with the second sensing units, wherein the pixel regions are defined by the drive-end traces, the receive-end traces, and the opaque insulating materials.

20. The method of claim 12, wherein the drive-end traces construct at least one finger-shaped sensing unit, the receive-end traces construct a plurality of opposing sensing units, the opposing sensing units and the finger-shaped sensing unit are arranged in a many-to-one manner alternately.

21. The method of claim 20, further comprising forming a plurality of opaque insulating materials connecting the finger-shaped sensing units with the opposing sensing units, wherein the pixel regions are defined by the drive-end traces, the receive-end traces, and the opaque insulating materials.
